(19) United States
(12) Patent Application Publication
(10) Pub. No.: US 2006/0085364 A1
(43) Pub. Date: Apr. 20, 2006

(54) Automated telephony services pricing application

(75) Inventors: Jaime J. Mosquera, St. Charles, MO (US); Roger Lyn Flynn, Bartlett, TN (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/969,768

(22) Filed: Oct. 20, 2004

(51) Int. Cl. G06F 17/00

(52) U.S. Cl. 705/400

(57) ABSTRACT

An automated pricing system determines a respective quote price for each of a plurality of different labor categories associated with an implementation of an Internet Protocol (IP) telephony system. The different labor categories comprise at least one field engineering category and at least one implementation manager category. The at least one field engineering category may comprise a field engineering cut coverage category. The at least one implementation manager category may comprise an implementation manager cut coverage category, an implementation manager call plan development category, an implementation manager project management category and an implementation manager training category.

FIELD OF THE DISCLOSURE

The present disclosure relates to methods and systems for determining installation and maintenance pricing for telecommunication products.

### BACKGROUND

To quote a price for an installation activity of a telecommunication product to a potential customer, a service coordinator works with field operations to subjectively determine the price. The price is subjectively determined based on an evaluation of a scope of work in the installation and manual references to manufacturer information for various devices in the installation.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram of an embodiment of an automated pricing system;

FIG. 2 is a block diagram of entities involved in an Internet Protocol telephony system for which the automated pricing system is used to determine quote values;

FIG. 3 is an example of output generated by the automated pricing system; and

FIG. 4 is an example of a user interface of the automated pricing system to receive structured cabling system selections.

### DETAILED DESCRIPTION OF THE DRAWINGS

Embodiments of the present invention provide an automated process and system for determining installation and maintenance pricing for telecommunication products. By establishing key evaluation criteria, objective assessments are made regarding the difficulty associated with a particular installation. The assessment of difficulty is translated into an expected number of hours and a quoted price for the installation activity.

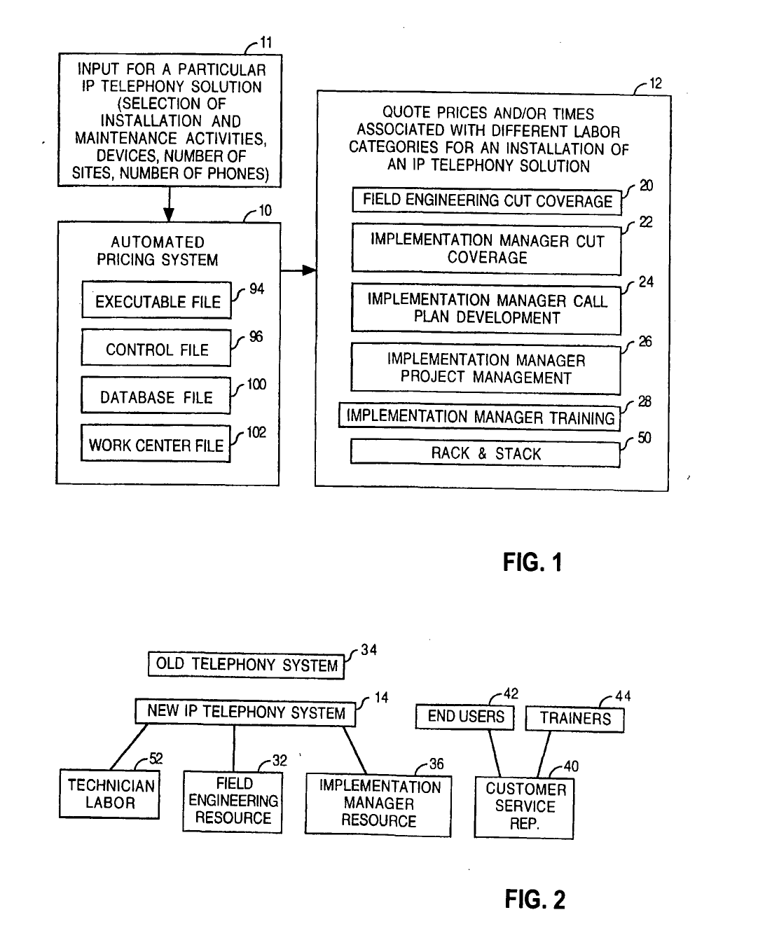

FIG. 1 is a block diagram of an automated pricing system 10 for quoting prices and/or times associated with an installation and/or maintenance of an Internet Protocol (IP) telephony system depicted in FIG. 2. In one embodiment, the automated pricing system 10 comprises a computer system which performs acts that are described hereinafter. The acts are directed by computer program code embodied in a computer-readable form on a computer-readable medium. The computer system comprises one or more computer processors responsive to the computer program code to perform the acts.

The automated pricing system 10 receives input 11 from a user that specifies features and aspects for a particular IP telephony solution whose price is to be quoted to a potential customer. The input 11 may indicate particular installation and maintenance activities, particular devices in the IP telephony solution, a number of sites involved in the IP telephony solution, a number of telephones involved at each of the sites, and who is to receive training for using the IP telephony solution. Based on the input 11, the automated pricing system 10 determines labor prices and/or labor times associated with support of an installation of an IP telephony system 14 for a potential customer, and generates an output 12 based thereon. The automated pricing system 10 may be used by sales personnel, for example, for pricing IP telephony services and other telecommunication services for potential customers.

The output 12 includes a respective labor price and/or labor time to quote for each of a plurality of different labor classifications or categories for the installation of the IP telephony system 14. The labor categories comprise at least one Field Engineering (FE) category and at least one Implementation Manager (IM) category. In one embodiment, the labor categories comprise Field Engineering (FE) Cut Coverage 20, Implementation Manager (IM) Cut Coverage 22, IM Call Plan Development 24, IM Project Management 26 and IM Training 28.

The FE Cut Coverage quote value 20 is a price and/or time associated with a time spent by a Field Engineering resource 32 after an initial IP telephony installation on a day the new IP telephony system 14 is cut over from an old telephone system 34. The IM Cut Coverage quote value 22 is a price and/or time associated with a time spent by an Implementation Manager resource 36 after the initial IP telephony installation on the day the new IP telephony system 14 is cut over from the old telephone system 34. The IM Project Management quote value 26 is a price and/or time associated with a time spent by the Implementation Manager resource 36 allocated to managing the project from start to finish. The IM Training quote value 28 is a price and/or time associated with a time spent by a Customer Service representative 40 allocated to training one or more end users 42 or one or more designated customer trainers 44 on the new IP telephony system 14.

The FE Cut Coverage quote value 20, the IM Cut Coverage quote value 22 and the IM Call Plan Development quote value 24 are functions of a number of sites and a number of IP phones in the installation of the IP telephony system 14. The IM Training quote value 28 is a function of the number of IP phones in the case of training the end users 42, or is a fixed value such as one day of labor for training the designated customer trainers 44. The IM Project Management quote value 26 is a mathematical step function that is a function of the number of IP phones.

The automated pricing system 10 determines the above quote values 20, 22, 24, 26 and 28 as follows:

FE Cut Coverage

Generally, the FE Cut Coverage quote value 20 is determined by determining, for each site in the IP telephony system 14, a respective amount of time allocated to field engineering cut coverage for the site based on a number of phones at the site, and determining the quote value 20 based on a product of a field engineering labor rate and a sum of each respective amount of time allocated to field engineering cut coverage.

In one embodiment, a respective number of hours are allocated to FE cut coverage for each site in the installation of the IP telephony system 14 as follows: 4 hours are allocated if the site is to have 0 to 24 phones; 8 hours are allocated if the site is to have 25 to 50 phones; and 16 hours are allocated if the site is to have 51 to 100 phones. The cost for FE Cut Coverage is the product of a labor rate for the FE resource 32 and a sum of the aforementioned FE Cut Coverage hours over all sites in the installation. A quoted sell price for the FE Cut Coverage is the aforementioned cost of FE cut coverage divided by (1−FE profit margin).

IM Cut Coverage

Generally, the IM Cut Coverage quote value 22 is determined by determining, for each site in the IP telephony system 14, a respective amount of time allocated to implementation manager cut coverage for the site based on a number of phones at the site, and determining the quote value 22 based on a product of an implementation manager labor rate and a sum of each respective amount of time allocated to implementation manager cut coverage.

In one embodiment, a respective number of hours are allocated to IM Cut Coverage for each site in the installation of the IP telephony system 14 as follows: 4 hours are allocated if the site is to have 0 to 24 phones; 8 hours are allocated if the site is to have 25 to 50 phones; and 16 hours are allocated if the site is to have 51 to 100 phones. The cost for IM Cut Coverage is the product of a labor rate for the IM resource 36 and a sum of the aforementioned IM Cut Coverage hours over all the sites in the installation. A quoted sell price for the IM Cut Coverage is the aforementioned cost of IM cut coverage divided by (1−IM profit margin).

IM Call Plan Development

Generally, the IM Call Plan Development quote value 24 is determined by determining, for each site in the IP telephony system 14, a respective amount of time allocated to implementation manager call plan development for the site based on a number of phones at the site, and determining the quote value 24 based on a product of an implementation manager labor rate and a sum of each respective amount of time allocated to implementation manager call plan development.

In one embodiment, a number of hours allocated to IM Call Plan Development for each site in the installation of the IP telephony system 14 is equal to a product of the number of phones at the site and a constant. The constant is equal to 8 hours divided by a call plan constant. The cost for IM Call Plan Development is the product of a labor rate for the IM resource 36 and a sum of the aforementioned IM Call Plan Development hours over all the sites in the installation. A quoted sell price for the IM Call Plan Development is the aforementioned cost of IM Call Plan Development divided by (1−IM profit margin).

IM Project Management

Generally, the IM Project Management quote value 26 is based on a total number of phones in the IP telephony system, and an amount of time allocated to IM Cut Coverage and IM Call Plan Development.

In one embodiment, the hours allocated to IM Project Management is a fraction of a sum of the hours allocated to IM Cut Coverage and IM Call Plan Development. The fraction, denoted by IMPercent, is a step function based on the number of phones to be installed in the IP telephony system 14. If the number of phones is greater than a threshold denoted as PhoneSlopePt, then the fraction is determined using the following equation:
IMPercent=(Locations−1)*LocIncrement+LocBase+SlopeIncrSecond*(Phones−PhoneSlopePt)/10,

where Locations is a value indicating a number of physical locations where work is being performed, LocIncrement is a constant multiplied by (Locations−1) whose net effect is to adjust neutrally/upwardly a percent value for IM project management hours, LocBase is a value indicating the base hours for IM project management as a percentage of cut coverage and call plan development, SlopeIncrSecond is a value indicating the linear slope of the equation and is related to the number of phones in all locations, and Phones is a value indicating the number of phones.

If the number of phones is less than or equal to the threshold PhoneSlopePt, then the fraction is determined using the following equation:
IMPercent=(Locations−1)*LocIncrement+LocBase/2+SlopeIncrFirst*Phones/10,

where SlopeIncrFirst is a value indicating the linear slope of the above equation.

The hours allocated to IM Project Management is IMPercent/100 times the sum of the hours allocated to IM Cut Coverage and IM Call Plan Development. The cost for IM Project Management is the product of a labor rate for the IM resource 36 and a sum of the aforementioned IM Project Management hours. A quoted sell price for the IM Project Management is the aforementioned cost of IM Project Management divided by (1−IM profit margin).

IM Pricing Adjustment

A pricing adjustment is made to the IM categories (IM Cut Coverage, IM Call Plan Development and IM Project Management) if a minimum threshold of hours is not met. In particular, if the sum of the IM Cut Coverage hours, the IM Call Plan Development hours and the IM Project Management hours is less than the threshold, then the total hours for the sum is set to a particular value, which is 40 hours in one embodiment. The time in each of the aforementioned labor categories is increased to stay within their original proportions but to sum to the particular value (e.g. 40 hours).

IM Training

Generally, the IM Training quote value 28 is based on whether one or more end users are to be trained, or one or more trainers are to be trained. If the end users 42 are to be trained, the quote value 28 is based on a number of phones for each site of the IP telephony system 14. If the trainers 44 are to be trained, the respective quote value 28 is based on a constant for each site of the IP telephony system 14.

In one embodiment, for each site in the installation of the IP telephony system 14, a number of hours are allocated to IM Training dependent on whether the end users 42 or the trainers 44 are to be trained. If the end users 42 are to be trained, then the IM training hours for a site is equal to a product of the number of phones at the site and a constant. The constant is equal to a quotient of a knowledge transfer time value and a knowledge transfer constant. If the trainers 44 are to be trained, then the IM training hours for a site is equal to the knowledge transfer time value.

The cost for IM Training is the product of a labor rate for IM and a sum of the aforementioned IM Training hours over all the sites in the installation. A quoted sell price for the IM Training is the aforementioned cost of IM Training divided by (1−IM profit margin).

Rack & Stack Calculation

A value associated with an additional labor category, called Rack & Stack, is determined and outputted by the automated pricing system 10. A Rack & Stack value 50 is determined by removing a first amount of time, such as one or more hours, from the installation of some items and allocating a second amount of time toward technician labor 52 without changing an overall price associated with the items. Thus, the net price remains the same after the rack & stack calculation, but an additional column is output to reflect activity by the technician labor 52.

The Rack & Stack value 50 is dependent upon the region in which the installation is performed due to labor differences from region-to-region. If the installation is performed in a region other than the southwest or midwest regions, the Rack & Stack value 50 is set to zero. If the installation is performed in the southwest or midwest regions, a number of hours allocated to install a particular device is compared to a rack & stack hours value. In one embodiment, the rack & stack hours value is a constant value of 1.5 technician hours. If the device install hours is greater than or equal to the rack & stack hours, then the quoted Rack & Stack value 50 is equal to the rack & stack hours times the technician labor rate, and the quoted device install price is equal to the device install price minus the aforementioned rack & stack price. If the device install hours is less than the rack & stack hours, then the quoted Rack & Stack value 50 is equal to zero, and the device install price is unchanged.

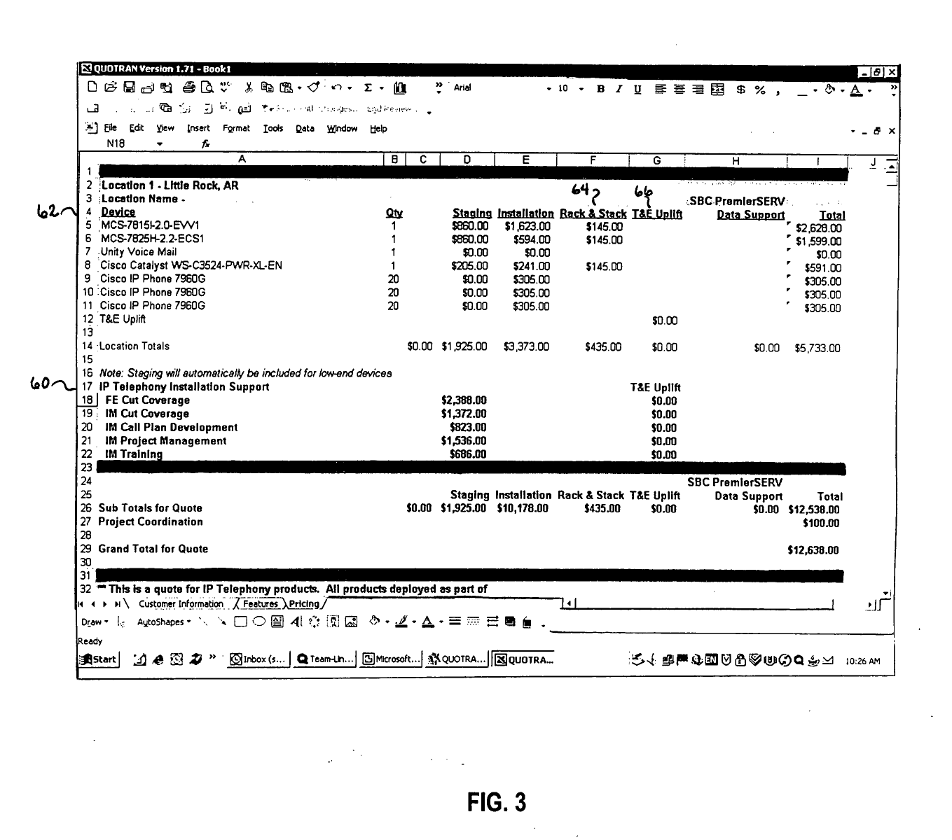

FIG. 3 is an example of the output 12 generated by the automated pricing system 10. In this embodiment, the output 12 has the form of a spreadsheet, although the automated pricing system 10 can generate the output 12 in other forms. The output 12 comprises a section 60 for IP telephony installation support. The section 60 includes rows having values for FE Cut Coverage, IM Cut Coverage, IM Call Plan Development, IM Project Management and IM Training.

The output 12 comprises a section 62 listing various devices involved in the installation. The section 62 has a column 64 indicating Rack & Stack prices associated with particular ones of the devices. The section 62 has a column 66 associated with T&E uplift, which are additional charges associated with mileage to a work site that is outside a normal boundary. The normal boundary may be a 50 mile radius from any of one or more particular cities with work centers. If the work site is within 50 miles of any of the particular cities with work centers, no additional charges are levied. If the work site is beyond these boundaries, additional charges are levied and reflected in the column 66.

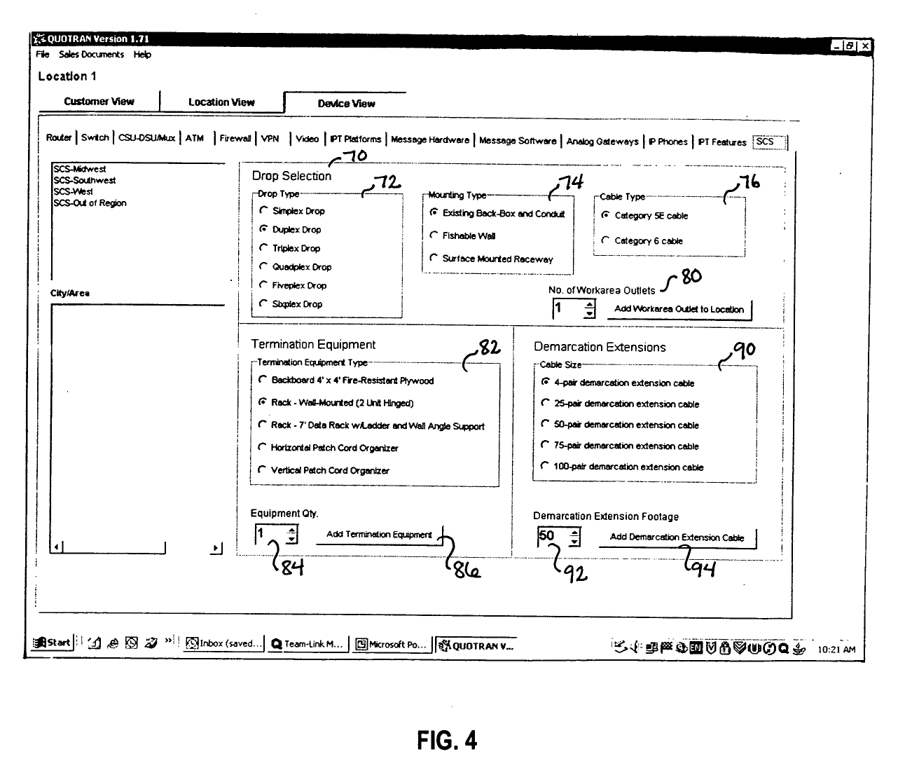

Referring back to FIG. 1, the automated pricing system 10 may be used to automatically generate quotable prices for installation and maintenance of telecommunication products other than IP telephony products. For installation and maintenance of telecommunication products that involve structured cabling systems (SCS), the automated pricing system 10 includes a user interface to receive SCS selections. An embodiment of the user interface is shown in FIG. 4.

FIG. 4 is an example of a user interface of the automated pricing system 10 to receive structured cabling system selections. The user interface allows users to make specific material selections for a structured cabling system.

The user interface includes a drop selection section 70. The drop selection section 70 includes a drop type selection section 72, a mounting type selection section 74, a cable type selection section 76, and a number of work area outlets selection section 80. The drop type selection section 72 provides a set of user-selectable drop types including a simplex drop, a duplex drop, a triplex drop, a quadplex drop, a fiveplex drop and a sixplex drop. The mounting type selection section 74 provides a set of user-selectable mounting types including an existing back-box and conduit type, a fishable wall type and a surface mounted raceway type. The cable type selection section 76 provides a set of cable types including Category 5E cable and Category 6 cable. The number of work area outlets selection section 72 enables a user to enter a number of work area outlets.

The user interface further includes a termination equipment selection section 82. The termination equipment selection section 82 provides a set of termination equipment types for a wire closet including a backboard 4-foot-by-4-foot fire-resistant plywood type, a wall-mounted rack (2 unit hinged) type, a 7-foot data rack with ladder and wall angle support type, a horizontal patch cord organizer type, and a vertical patch cord organizer type. Additional termination equipment can be added using controls 84 and 86.

The user interface still further includes a demarcation extensions selection section 90. The demarcation extensions selection section 90 provides a set of user-selectable demarcation extension cable sizes including a 4-pair type, a 25-pair type, a 50-pair type, a 75-pair type, and a 100-pair type. A length of the demarcation extension cable can be entered using controls 92 and 94.

In general, the computer program code to cause the automated pricing system 10 to perform the herein-disclosed acts may be structured in various ways. Referring back to FIG. 1, the computer program code in one embodiment comprises an executable file 94, a control file 96, a database file 100 and work centers file 102. The control file 96 is a text file which contains the constants used to determine the pricing values. The database file 100 is a file of information for installation and maintenance activities offered by a telecommunication business. The work centers file 102 is a database file of cities where work centers exist.

The executable file 94 reads the control file 96, the database file 100 and the work centers file 102 at run-time. The executable file 94 causes the automated pricing system 10 to: provide the user interfaces to receive the input 11; process the input 11 using data from the control file 96, the database file 100 and the work centers file 102 to generate quotable pricing data; and output the quotable pricing data. The quotable pricing data may be outputted in various forms, including but not limited to a spreadsheet form.

It will be apparent to those skilled in the art that the disclosed embodiments may be modified in numerous ways and may assume many embodiments other than the forms specifically set out and described herein.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
determining a respective quote price for each of a plurality of different labor categories associated with an implementation of an Internet Protocol (IP) telephony system, the different labor categories comprising at least one field engineering category and at least one implementation manager category.

2. The method of claim 1 wherein the at least one field engineering category comprises a field engineering cut coverage category.

3. The method of claim 2, wherein determining the respective quote price for the field engineering cut coverage category comprises:
determining, for each site in the IP telephony system, a respective amount of time allocated to field engineering cut coverage for the site based on a number of phones at the site; and
determining the respective quote price based on a product of a field engineering labor rate and a sum of each respective amount of time allocated to field engineering cut coverage.

4. The method of claim 1 wherein the at least one implementation manager category comprises an implementation manager cut coverage category, an implementation manager call plan development category, an implementation manager project management category and an implementation manager training category.

5. The method of claim 1 wherein the at least one implementation manager category comprises an implementation manager cut coverage category.

6. The method of claim 1 wherein determining the respective quote price for the implementation manager cut coverage category comprises:
determining, for each site in the IP telephony system, a respective amount of time allocated to implementation manager cut coverage for the site based on a number of phones at the site; and
determining the respective quote price based on a product of an implementation manager labor rate and a sum of each respective amount of time allocated to implementation manager cut coverage.

7. The method of claim 1 wherein the at least one implementation manager category comprises an implementation manager call plan development category.

8. The method of claim 7 wherein determining the respective quote price for the implementation manager call plan development category comprises:
determining, for each site in the IP telephony system, a respective amount of time allocated to implementation manager call plan development for the site based on a number of phones at the site; and
determining the respective quote price based on a product of an implementation manager labor rate and a sum of each respective amount of time allocated to implementation manager call plan development.

9. The method of claim 1 wherein the at least one implementation manager category comprises an implementation manager project management category.

10. The method of claim 9 wherein determining the respective quote price for the implementation manager project management category is based on a total number of phones.

11. The method of claim 1 wherein the at least one implementation manager category comprises an implementation manager training category.

12. The method of claim 1 1 wherein determining the respective quote price for the implementation manager training category is based on whether one or more end users or one or more trainers are to be trained.

13. The method of claim 12 wherein if the end users are to be trained, the respective quote price for the implementation manager training category is based on a number of phones, and wherein if the trainers are to be trained, the respective quote price for the implementation manager training category is based on a constant for each site.

14. The method of claim 1 further comprising determining a quote for a rack-and-stack category by removing a first amount of time from an installation of an item and allocating a second amount of time toward technician labor for the item without changing an overall price associated with the item.

15. A computer-readable medium having computer-readable program code to cause a computer system to perform an act of:
determining a respective quote price for each of a plurality of different labor categories associated with an implementation of an Internet Protocol (IP) telephony system, the different labor categories comprising at least one field engineering category and at least one implementation manager category.

16. The computer-readable medium of claim 15 wherein the at least one field engineering category comprises a field engineering cut coverage category.

17. The computer-readable medium of claim 15 wherein determining the respective quote price for the field engineering cut coverage category comprises:
determining, for each site in the IP telephony system, a respective amount of time allocated to field engineering cut coverage for the site based on a number of phones at the site; and
determining the respective quote price based on a product of a field engineering labor rate and a sum of each respective amount of time allocated to field engineering cut coverage.

18. The computer-readable medium of claim 15 wherein the at least one implementation manager category comprises an implementation manager cut coverage category, an implementation manager call plan development category, an implementation manager project management category and an implementation manager training category.

19. The computer-readable medium of claim 15 wherein the at least one implementation manager category comprises an implementation manager cut coverage category.

20. The computer-readable medium of claim 15 wherein determining the respective quote price for the implementation manager cut coverage category comprises:
determining, for each site in the IP telephony system, a respective amount of time allocated to implementation manager cut coverage for the site based on a number of phones at the site; and
determining the respective quote price based on a product of an implementation manager labor rate and a sum of each respective amount of time allocated to implementation manager cut coverage.

21. The computer-readable medium of claim 15 wherein the at least one implementation manager category comprises an implementation manager call plan development category.

22. The computer-readable medium of claim 21 wherein determining the respective quote price for the implementation manager call plan development category comprises:
determining, for each site in the IP telephony system, a respective amount of time allocated to implementation manager call plan development for the site based on a number of phones at the site; and
determining the respective quote price based on a product of an implementation manager labor rate and a sum of each respective amount of time allocated to implementation manager call plan development.

23. The computer-readable medium of claim 15 wherein the at least one implementation manager category comprises an implementation manager project management category.

24. The computer-readable medium of claim 23 wherein determining the respective quote price for the implementation manager project management category is based on a total number of phones in the IP telephony system.

25. The computer-readable medium of claim 15 wherein the at least one implementation manager category comprises an implementation manager training category.

26. The computer-readable medium of claim 25 wherein determining the respective quote price for the implementation manager training category is based on whether one or more end users or one or more trainers are to be trained.

27. The computer-readable medium of claim 26 wherein if the end users are to be trained, the respective quote price for the implementation manager training category is based on a number of phones for each site of the IP telephony system, and wherein if the trainers are to be trained, the respective quote price for the implementation manager training category is based on a constant for each site of the IP telephony system.

28. The computer-readable medium of claim 15 wherein the computer-readable program code further causes the computer system to perform an act of:
determining a quote for a rack-and-stack category by removing a first amount of time from an installation of an item and allocating a second amount of time toward technician labor for the item without changing an overall price associated with the item.

29. A method comprising:
providing a user interface to receive structured cabling system (SCS) selections in an automated pricing application, the SCS selections including a drop type selection, a mounting type selection, a cable type selection, a number of work area outlets selection, a termination equipment selection and a demarcation extensions selection.

30. A computer-readable medium having computer-readable program code to cause a computer system to:
provide a user interface to receive structured cabling system (SCS) selections in an automated pricing application, the SCS selections including a drop type selection, a mounting type selection, a cable type selection, a number of work area outlets selection, a termination equipment selection and a demarcation extensions selection.
